(19) United States
(12) Patent Application Publication
(10) Pub. No.: US 2026/0118215 A1
(43) Pub. Date: Apr. 30, 2026

(54) METHOD AND DEVICE FOR TESTING OPTICAL LINK BASED ON OPTICAL FREQUENCY DOMAIN REFLECTOMETRY

(71) Applicant: BEIJING AEROSPACE INSTITUTE FOR METROLOGY AND MEASUREMENT TECHNOLOGY, Beijing (CN)

(72) Inventors: Yuxiang FENG, Beijing (CN); Yinxiao MIAO, Beijing (CN); Chen WU, Beijing (CN); Meng ZHANG, Beijing (CN); Jingcan MA, Beijing (CN); Xiang TAO, Beijing (CN); Yixuan ZHANG, Beijing (CN); Ya GAO, Beijing (CN); Yapeng PEI, Beijing (CN); Tieli ZHANG, Beijing (CN)

(21) Appl. No.: 19/433,444

(22) Filed: Dec. 26, 2025

(30) Foreign Application Priority Data
Jan. 8, 2025 (CN) 202510026441.7

(51) Int. Cl. G01M 11/00; G02B 6/12; G02B 6/125

(52) U.S. Cl. CPC G01M 11/3172; G02B 6/125; G02B 2006/12147; G02B 2006/12159

(57) ABSTRACT

A method for testing an optical link based on optical frequency domain reflectometry includes: measuring, by a frequency domain reflectometer, a return optical signal in an optical link in an initial state, to obtain a first signal; measuring, by the frequency domain reflectometer, a return optical signal in the optical link in a changed state, to obtain a second signal; performing a fast Fourier transform on the first signal and the second signal, respectively, to obtain a frequency domain signal of the first signal and a frequency domain signal of the second signal, whereby obtaining a relationship curve between a distance and a frequency shift; extracting and converting same frequency band from two frequency domain signals by using a sliding window into time domain signals, and performing a cross-correlation calculation on two set of time domain signals to obtain a Rayleigh scattering frequency shift.

### CROSS-REFERENCE TO RELATED APPLICATIONS

This application claims the benefit of priority from Chinese Patent Application No. 202510026441.7, filed on Jan. 8, 2025. The content of the aforementioned application, including any intervening amendments thereto, is incorporated herein by reference in its entirety.

### TECHNICAL FIELD

This application relates to the field of electronic information technology, and more particularly to a method and device for testing an optical link based on optical frequency domain reflectometry.

### BACKGROUND

On-chip optical links, with their advantages of high efficiency, light weight, and anti-interference characteristics, as well as their seamless integration capabilities with optical fiber communication and sensing networks, possess high-precision broadband sensing and transmission capability at large scales, and efficient information processing capability at small scales. This signal consistency across macro, meso, and micro scales helps to avoid energy and information losses in a link caused by frequent electro-optic conversions, thereby maximizing efficiency. As a prerequisite for large-scale applications of on-chip optical links, parameters such as input/output power and noise at key nodes and devices along the link need to be accurately measured as critical data for the optimization of optical link performance.

In the related art, conventional methods for calibrating on-chip optical links include temperature compensation calibration, feedback-based adaptive calibration, electrical/optical signal calibration, static calibration for manufacturing deviations, and multi-point sampling and interpolation calibration. However, these methods all have certain defects. For example:
it is difficult for the temperature compensation calibration to promptly respond to sudden temperature changes due to a slow response speed of a temperature sensor, and the temperature compensation calibration may by unable to eliminate effects caused by manufacturing process differences. The feedback-based adaptive calibration relies on complex feedback circuits, which may increase the power consumption and design complexity of the chip, and a feedback calibration usually responds slowly to sudden environmental changes. The electrical/optical signal calibration requires additional conversion circuits, which may increase a chip area, and as link speeds increase, it is difficult to avoid the impact of noise during electro-optic/optical-electrical conversion. The static calibration for manufacturing deviations is only effective in an initial state, and is difficult to adapt to subsequent environmental changes and device aging, making it impossible to provide long-term link stability. The multi-point sampling and interpolation calibration is time-consuming during sampling and interpolation, which may result in non-real-time link calibration, and the multi-point sampling and interpolation calibration fails when environmental changes exceed the sampling range. Based on the aforementioned defects, the present disclosure provides a method and device for testing an optical link based on optical frequency domain reflectometry, aiming to address these issues.

### SUMMARY

Based on above, to solve the problems in the related art, in one aspect, the present disclosure provides a method for testing an optical link based on optical frequency domain reflectometry, including:
measuring and demodulating, by a frequency domain reflectometer, a return optical signal of a probe optical signal from the frequency domain reflectometer in an optical link in an initial state, to obtain a first signal, wherein the return optical signal carries information of an amplitude and a phase of an optical field at a node to-be-tested in the optical link in the initial state;
adjusting and controlling a photoelectric control unit in an on-chip optical link to change a state of the optical link, and measuring and demodulating, by the frequency domain reflectometer, a return optical signal of the probe optical signal from the frequency domain reflectometer in the optical link in the changed state, to obtain a second signal, wherein the return optical signal carries information of an amplitude and a phase of an optical field at the node to-be-tested in the optical link in the changed state;
performing a fast Fourier transform on the first signal and the second signal, respectively, to obtain a frequency domain signal of the first signal and a frequency domain signal of the second signal;
performing an inverse fast Fourier transform on a signal segment of the frequency domain signal of the first signal and a signal segment of the frequency domain signal of the second signal, respectively, to obtain a time domain signal of the first signal and a time domain signal of the second signal, whereby obtaining a relationship curve between a distance and a frequency shift;
performing a cross-correlation calculation on the time domain signal of the first signal and the time domain signal of the second signal to obtain a Rayleigh scattering frequency shift at each node to-be-tested in the entire optical link; and
performing a calculation based on a coefficient to obtain a curve between the distance from the frequency domain reflectometer to the node to-be-tested in the optical link and a power distribution, whereby obtaining a phase and amplitude modulation result of the return optical signal after passing through the optical link.

Further, before measuring, by the frequency domain reflectometer, the return optical signal to obtain the first signal, the method further includes:
connecting an output terminal of the frequency domain reflectometer to an input terminal of the on-chip optical link via an optical fiber, and connecting an input terminal of the frequency domain reflectometer to an output terminal of the on-chip optical link via the optical fiber, whereby forming a loop.

In an embodiment, before performing the inverse fast Fourier transform on the frequency domain signal of the first signal and the frequency domain signal of the second signal, respectively, the method further includes:
performing an extract on the frequency domain signal of the first signal at the node to-be-tested by using a fixed moving window to obtain the signal segment of the frequency domain signal of the first signal, and performing an extract on the frequency domain signal of the second signal at the node to-be-tested by using the fixed moving window to obtain the signal segment of the frequency domain signal of the second signal.

In an embodiment, the on-chip optical link includes a protective layer, a link testing layer, an isolation layer, and a functional layer that are sequentially stacked.

In an embodiment, the functional layer is in the form of a Mach-Zehnder structure or a micro-ring structure.

In an embodiment, a laser linear frequency modulation bandwidth of the frequency domain reflectometer system ranges from 10 nm to 50 nm.

In another aspect, the present disclosure provides a device for testing an optical link based on optical frequency domain reflectometry. The device includes a frequency domain reflectometer and at least one set of on-chip optical links. An output terminal of the frequency domain reflectometer is connected to an input terminal of the on-chip optical link via an optical fiber, and an input terminal of the frequency domain reflectometer is connected to an output terminal of the on-chip optical link via an optical fiber.

In an embodiment, the on-chip optical link includes a protective layer, a link testing layer, an isolation layer, and a functional layer that are sequentially stacked.

In an embodiment, the functional layer is in the form of a Mach-Zehnder structure or a micro-ring structure.

Compared to the prior art, the present disclosure has the following beneficial effects.

By adopting the method of the present disclosure, the relationship curve between the distance and the frequency shift and the curve between the distance and the power distribution can be obtained. Through analysis of the relationship curve between the distance and the frequency shift and the curve between the distance and the power distribution, amplitude and phase parameters of the optical field of an integrated system can be rapidly and accurately measured and calibrated from a device level to a link level, and parameters, such as return loss, insertion loss, spectrum, and delay of the on-chip optical link, can be efficiently measured, thereby effectively overcoming the deficiencies present in various testing methods in the related art.

### BRIEF DESCRIPTION OF THE DRAWINGS

In order to illustrate technical solutions in embodiments of the present disclosure or the related art more clearly, the accompanying drawings needed in the description of the embodiments or related art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a schematic flow chart of a method for testing an optical link based on optical frequency domain reflectometry according to an embodiment of the present disclosure;

FIG. 2 is a flow chart illustrating signal processing processes of the method according to an embodiment of the present disclosure;

FIG. 3 is a schematic structural view of a device for testing an optical link based on optical frequency domain reflectometry according to an embodiment of the present disclosure; and

FIG. 4 is a schematic structural view of an on-chip optical link of the device according to an embodiment of the present disclosure.

Reference numerals in the figures: 1—frequency domain reflectometer, 2—on-chip optical link, 21—protective layer, 22—link testing layer, 23—isolation layer, 24—functional layer, 3—optical fiber.

The implementations, functional characteristics, and advantages of the present disclosure will be further explained in conjunction with the embodiments and the accompanying drawings.

### DETAILED DESCRIPTION OF EMBODIMENTS

The technical solutions in embodiments of the present disclosure will be described clearly and completely below in conjunction with the accompanying drawings in the embodiments of the present disclosure. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

It is noted that all directional indications (such as upper, lower, left, right, front, rear, etc.) in the embodiments of the present disclosure are merely used to explain the relative relationships of nodes to-be-tested, motion conditions, and the like between various components, under a specific posture (as shown in the accompanying drawings). If the specific posture changes, such directional indications shall change accordingly.

Additionally, in the present disclosure, descriptions involving “first,” “second,” and the like are used merely for descriptive purposes and shall not be construed as indicating or implying relative importance, nor as implicitly specifying the number of the indicated technical features. Thus, a feature defined by “first” or “second” may explicitly or implicitly include at least one such feature. In addition, “and/or” herein includes three alternatives; taking A and/or B as an example, it includes a technical solution of A, a technical solution of B, and a technical solution in which both A and B are satisfied simultaneously. Further, the technical solutions of the various embodiments may be combined with each other, provided that such combinations are achievable by a person of ordinary skill in the art. When a combination of technical solutions results in mutual contradiction or is not achievable, such a combination shall be deemed not to exist and shall not fall within the protection scope of the present disclosure.

The present disclosure is advantageous for integrated and miniaturized development and can be applied in multiple fields such as communication, artificial intelligence, and structural health monitoring, solving issues such as online error correction and distributed measurement in optical links.

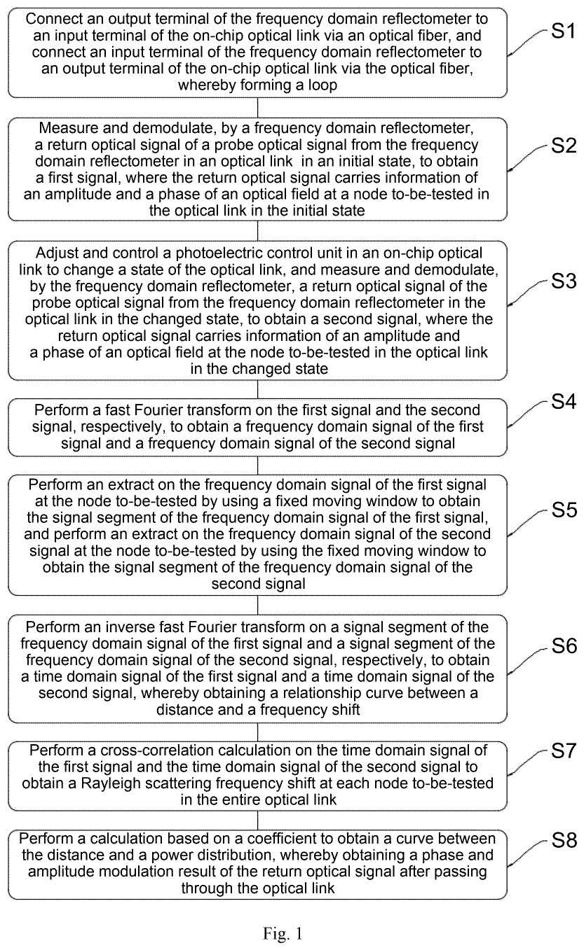

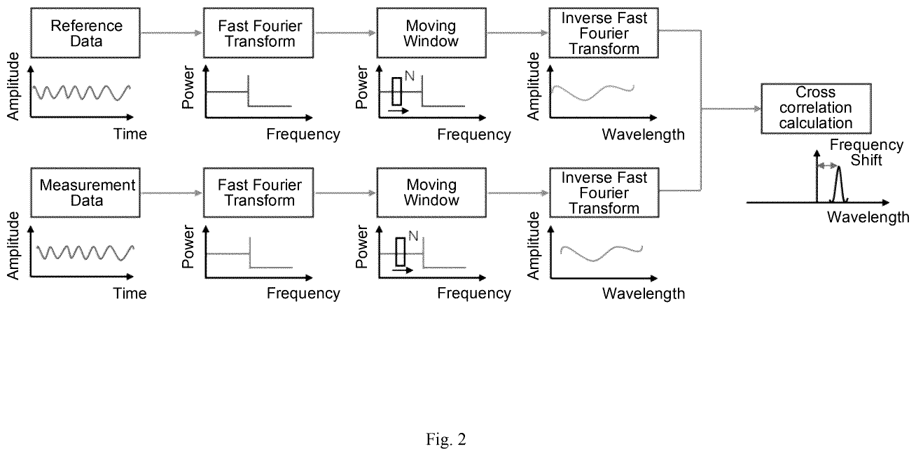

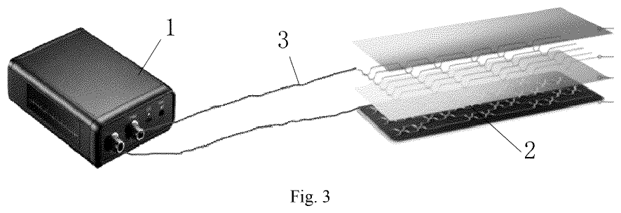

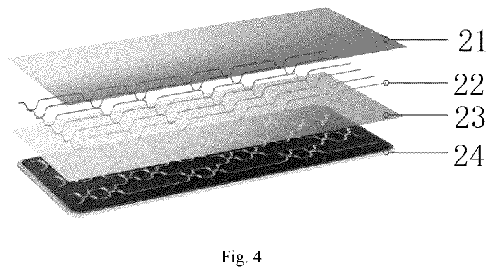

As shown in FIGS. 1 to 4, the embodiments of the disclosure provide a method for testing an optical link based on optical frequency domain reflectometry. The method includes the following steps.

At S1, an output terminal of the frequency domain reflectometer is connected to an input terminal of the on-chip optical link via an optical fiber, and an input terminal of the frequency domain reflectometer is connected to an output terminal of the on-chip optical link via the optical fiber, to form a loop.

At S2, a frequency domain reflectometer measures and demodulates a return optical signal of a probe optical signal from the frequency domain reflectometer in an optical link in an initial state, to obtain a first signal, where the return optical signal carries information of an amplitude and a phase of an optical field at a node to-be-tested in the optical link in the initial state.

At S3, a photoelectric control unit in an on-chip optical link is adjusted and controlled to change a state of the optical link, and the frequency domain reflectometer measures and demodulates a return optical signal of the probe optical signal from the frequency domain reflectometer in the optical link in the changed state, to obtain a second signal, where the return optical signal carries information of an amplitude and a phase of an optical field at the node to-be-tested in the optical link in the changed state.

At S4, a fast Fourier transform is performed on the first signal and the second signal, respectively, to obtain a frequency domain signal of the first signal and a frequency domain signal of the second signal.

At S5, an extract is performed on the frequency domain signal of the first signal at the node to-be-tested by using a fixed moving window to obtain the signal segment of the frequency domain signal of the first signal, and an extract is performed on the frequency domain signal of the second signal at the node to-be-tested by using the fixed moving window to obtain the signal segment of the frequency domain signal of the second signal.

At S6, an inverse fast Fourier transform is performed on a signal segment of the frequency domain signal of the first signal and a signal segment of the frequency domain signal of the second signal, respectively, to obtain a time domain signal of the first signal and a time domain signal of the second signal, whereby obtaining a relationship curve between a distance from the frequency domain reflectometer to the node to-be-tested in the optical link and a frequency shift.

At S7, a cross-correlation calculation is performed on the time domain signal of the first signal and the time domain signal of the second signal to obtain a Rayleigh scattering frequency shift at each node to-be-tested in the entire optical link.

At S8, a calculation is performed based on a coefficient to obtain a curve between the distance from the frequency domain reflectometer to the node to-be-tested in the optical link and a power distribution, whereby obtaining a phase and amplitude modulation result of the return optical signal after passing through the optical link.

In the embodiments, the on-chip optical link is provided with a protective layer, a link testing layer, an isolation layer, and a functional layer. The return optical signal from the frequency domain reflectometer is connected to the functional layer via optical fibers. A backscattering light signal of a measured light enters the testing layer through evanescent-wave coupling, and is then transmitted back to the frequency domain reflectometer. In a demodulation system of the optical frequency reflectometer, processes such as interference, photoelectric conversion, data sampling, and analog-to-digital conversion are completed, and demodulation is eventually accomplished through a signal processing algorithm, thereby obtaining test results of the on-chip optical link.

By performing cross-correlation calculations on two sets of time-domain signals, a similarity between signals is calculated to obtain the Rayleigh scattering frequency shift. The Rayleigh scattering frequency shift reflects state changes in the optical link, such as power variations or link disturbances.

In the steps, the relationship curve between the distance from the frequency domain reflectometer to the node to-be-tested in the optical link and the frequency shift is obtained, which reflects state changes of the optical link at different positions. The curve between the distance from the frequency domain reflectometer to the node to-be-tested in the optical link and the power distribution is also obtained, which reflects a power intensity of a return signal at each point in the optical link.

By designing a multilayer structure and utilizing an on-chip waveguide structure to perform evanescent-wave coupling to form a monitoring network, amplitude and phase calibration from a device level to a link level is achieved. Parameters such as return loss, insertion loss, spectrum, and delay of the link can be efficiently measured, thereby achieving a distributed measurement function.

Formulas for calculating the curve between the distance and the power distribution include:

$$B = S \times T ; \qquad Formula 1$$

$$R = \frac{f c}{2 S} ; \qquad Formula 2$$

$$Substituting Formula 1 into Formula 2 yields Formula 3 : R = \frac{c T}{2 B} f .$$

A spatial resolution calculation formula is: ΔR=c/(2×B), B=c/(2×ΔR), where R represents the distance from the frequency domain reflectometer to the node to-be-tested in the optical link; ΔR represents a spatial resolution; B represents a laser linear frequency modulation bandwidth of the frequency domain reflectometer system; S represents a linear frequency modulation rate; T represents a signal time width; f represents an intermediate frequency signal frequency;

$$\frac{c T}{2 B}$$

is a coefficient; and c represents the speed of light.

At S7, the cross-correlation calculation formula is: C_{AB}(Δλ)=∫A(λ). B(λ+Δλ)dλ, where A(λ) represents the first signal, with a wavelength λ as a horizontal axis and an amplitude as a vertical axis; B(λ) represents the second signal, with a wavelength λ as a horizontal axis and an amplitude as a vertical axis; Δλ represents the wavelength shift (analogous to a delay in a time domain); and C_{AB}(Δλ) represents a cross-correlation result under the wavelength shift.

By adopting the method of the present disclosure, the relationship curve between the distance and the frequency shift and the curve between the distance and the power distribution can be obtained. Through analysis of the results of the relationship curve between the distance and the frequency shift and the curve between the distance and the power distribution, rapid and accurate measurement and calibration for amplitude and phase parameters of the optical field of an integrated system from a device level to a link level can be achieved, and parameters such as return loss, insertion loss, spectrum, and delay of the on-chip optical link can be efficiently measured, thereby effectively overcoming the deficiencies present in various testing methods in the related art.

In one embodiment, the on-chip optical link includes the protective layer 21, the link testing layer 22, the isolation layer 23, and the functional layer 24 that are sequentially stacked.

In the embodiments, the functional layer 24 is in the form of a Mach-Zehnder structure or a micro-ring structure. By such an arrangement, a waveguide layer is added without changing the original structure of an optical link device, so that amplitude and phase information of a designated node to-be-tested can be rapidly and efficiently obtained, thereby providing significant advantages in large-scale optical links.

In one embodiment, the laser linear frequency modulation bandwidth of the frequency domain reflectometer 1 ranges from 10 nm to 50 nm.

In the embodiments, the frequency domain reflectometer 1 is composed of two directional couplers and one phase shifter, with a length of approximately 200 μm and a width of 50 μm. Two monitoring points are provided at an input and an output of the structure, with a spatial interval between the two points of about 100 μm. This requires that a spatial resolution of the frequency domain reflectometer 1 be less than 50 μm in order to distinguish return optical signals from the two monitoring points. According to the spatial resolution calculation formula, it can be derived that the laser linear frequency modulation bandwidth of the frequency domain reflectometer 1 needs to be 10 nm to 50 nm.

The embodiments of the present disclosure provide a device for testing an optical link based on optical frequency domain reflectometry. The device includes:
a frequency domain reflectometer 1; and
at least one set of on-chip optical links 2, where the input terminal and the output terminal of the frequency domain reflectometer 1 are correspondingly connected to the input terminal and the output terminal of the on-chip optical link 2 via optical fibers 3.

In the embodiment, the on-chip optical link includes the protective layer 21, the link testing layer 22, the isolation layer 23, and the functional layer 24 that are sequentially stacked.

In the embodiments, the functional layer 24 is in the form of a Mach-Zehnder structure or a micro-ring structure. By such an arrangement, a waveguide layer is added without changing the original structure of the optical link device, so that amplitude and phase information of a designated node to-be-tested can be rapidly and efficiently obtained, thereby providing significant advantages in large-scale optical links.

The return optical signal from the frequency domain reflectometer is connected to the functional layer 24 via the optical fibers 3. A backscattering light signal of a measured light enters the testing layer through evanescent-wave coupling, and is then transmitted back to the frequency domain reflectometer. In a demodulation system of the optical frequency reflectometer, processes such as interference, photoelectric conversion, data sampling, and analog-to-digital conversion are completed, and demodulation is eventually accomplished through a signal processing algorithm.

In one embodiment, the laser linear frequency modulation bandwidth of the frequency domain reflectometer 1 ranges from 10 nm to 50 nm.

In the embodiments, the frequency domain reflectometer 1 is composed of two directional couplers and one phase shifter, with a length of approximately 200 μm and a width of 50 μm. Two monitoring points are provided at an input and an output of the structure, with a spatial interval between the two points of about 100 μm. This requires that a spatial resolution of the frequency domain reflectometer 1 be less than 50 μm in order to distinguish return optical signals from the two monitoring points. According to the spatial resolution calculation formula, it can be derived that the laser linear frequency modulation bandwidth of the frequency domain reflectometer 1 needs to be 10 nm to 50 nm.

Described above are only preferred embodiments of the present disclosure, which are not intended to limit the scope of the present disclosure. Any equivalent structural modifications made under the concept of the present disclosure by using the description and the drawings of the present disclosure, or any direct or indirect application thereof in other related technical fields, shall fall within the protection scope of the present disclosure defined by the appended claims.

What is claimed is:

1. A method for testing an optical link based on optical frequency domain reflectometry, comprising:
measuring and demodulating, by a frequency domain reflectometer, a return optical signal of a probe optical signal from the frequency domain reflectometer in an optical link in an initial state, to obtain a first signal, wherein the return optical signal carries information of an amplitude and a phase of an optical field at a node to-be-tested in the optical link in the initial state;
adjusting and controlling a photoelectric control unit in the optical link to change a state of the optical link, and measuring and demodulating, by the frequency domain reflectometer, a return optical signal of the probe optical signal from the frequency domain reflectometer in the optical link in the changed state, to obtain a second signal, wherein the return optical signal carries information of an amplitude and a phase of an optical field at the node to-be-tested in the optical link in the changed state;
performing a fast Fourier transform on the first signal and the second signal, respectively, to obtain a frequency domain signal of the first signal and a frequency domain signal of the second signal;
performing an inverse fast Fourier transform on a signal segment of the frequency domain signal of the first signal and a signal segment of the frequency domain signal of the second signal, respectively, to obtain a time domain signal of the first signal and a time domain signal of the second signal, whereby obtaining a relationship curve between a distance from the frequency domain reflectometer to the node to-be-tested in the optical link and a frequency shift;
performing a cross-correlation calculation on the time domain signal of the first signal and the time domain signal of the second signal to obtain a Rayleigh scattering frequency shift at each node to-be-tested in the entire optical link; and
performing a calculation based on a coefficient to obtain a curve between the distance from the frequency domain reflectometer to the node to-be-tested in the optical link and a power distribution, whereby obtaining a phase and amplitude modulation result of the return optical signal after passing through the optical link.

2. The method according to claim 1, wherein before measuring, by the frequency domain reflectometer, the return optical signal to obtain the first signal, the method further comprises:
connecting an output terminal of the frequency domain reflectometer to an input terminal of the optical link via an optical fiber, and connecting an input terminal of the frequency domain reflectometer to an output terminal of the optical link via the optical fiber, whereby forming a loop.

3. The method according to claim 1, wherein before performing the inverse fast Fourier transform on the frequency domain signal of the first signal and the frequency domain signal of the second signal, respectively, the method further comprises:
performing an extract on the frequency domain signal of the first signal at the node to-be-tested by using a fixed moving window to obtain the signal segment of the frequency domain signal of the first signal, and performing an extract on the frequency domain signal of the second signal at the node to-be-tested by using the fixed moving window to obtain the signal segment of the frequency domain signal of the second signal.

4. The method according to claim 2, wherein the optical link comprises a protective layer, a link testing layer, an isolation layer, and a functional layer that are sequentially stacked.

5. The method according to claim 4, wherein the functional layer is in the form of a Mach-Zehnder structure or a micro-ring structure.

6. The method according to claim 1, wherein a laser linear frequency modulation bandwidth of the frequency domain reflectometer system ranges from 10 nm to 50 nm.
